(19) United States
(12) Patent Application Publication
(10) Pub. No.: US 2010/0111389 A1
(43) Pub. Date: May 6, 2010

(54) SYSTEM AND METHOD FOR PLANNING AND GUIDING PERCUTANEOUS PROCEDURES

(75) Inventors: Norbert Strobel, Heroldsbach (DE); Adam K. Galant, Carpentersville, IL (US); Liron Yatziv, Fremont, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/329,657

(22) Filed: Dec. 8, 2008

Related U.S. Application Data
(60) Provisional application No. 60/992,830, filed on Dec. 6, 2007.

(51) Int. Cl. G06K 9/00; G01N 23/04; H05G 1/60; G06T 15/00

(52) U.S. Cl. 382/131; 378/62; 378/21; 345/419; 382/154

(57) ABSTRACT

A system and method are disclosed for planning a percutaneous procedure and for guiding an instrument to engage a target within a patient's body. A patient 3-dimensional image data set is provided, within which a user selects a skin entry point and a target point. A line, or “planned path,” is generated between the points which is used to align a movable arm to achieve a “Bull's Eye View,” in which the two points are superimposed. The instrument is placed at the skin entry point and aligned using the Bull's Eye View along a desired trajectory that intersects the target. Initial alignment is verified using fluoroscopy. Progression fluoroscopic views are used during the insertion procedure to ensure the instrument remains on the planned path. When the instrument reaches the target, a procedure may be performed, such as a biopsy, a drainage procedure, a radiofrequency ablation, or other medical interventional procedure.

### CROSS-REFERENCE TO RELATED APPLICATIONS

This is a non-provisional application of pending U.S. provisional patent application Ser. No. 60/992,830, filed Dec. 6, 2007 by Strobel et al., the entirety of which application is incorporated by reference herein.

### FIELD OF THE DISCLOSURE

The disclosure is related to methods for performing percutaneous procedures, and more particularly to improved guidance methods for percutaneous procedures utilizing movable arm fluoroscopic devices.

### BACKGROUND

Percutaneous procedures, such as needle biopsies, drainages, radiofrequency ablations, and other medical interventional procedures, are often performed using X-ray fluoroscopy devices. In an attempt to reduce procedure times as well as radiation exposure to both the user and the patient, while improving targeting accuracy, the use of laser pointer devices has been proposed. The laser pointer may be mounted on the C-arm and aligned with a pair of points, one on the skin entry position and another on a targeted site within the patient. The needle or other instrument is aligned with the laser beam and inserted along the line defined by the laser.

When using laser pointers, however, unless the laser beam (or a laser cross formed by two laser fan beams) can be flexibly steered, the use of a fixed laser guide device requires moving the patient table to align the needle trajectory with the direction of the laser. A popular choice is to align the laser with the central ray of the C-arm system passing through the C-arm iso-center. As noted, however, such alignment of the needle trajectory with this fixed laser guide direction may require shifting the patient table. This can be cumbersome and may even put some patients (e.g., large patients) on a collision course with the C-arm as the system elements are moved around the patient to provide the different image views (e.g., Bull's Eye view, progression view, C-arm CT image acquisition (e.g., DynaVision) runs) that are often acquired during the alignment and insertion procedures.

A further issue relating to requiring table movement as part of a procedure is that it may result in registration errors between the live fluoroscopic image and the volumetric data set used to visualize the target within the patient. Since the needle trajectory is often planned using such a volumetric data set (created using the C-arm system itself or registered to a C-arm CT volume), if the table is moved after such C-arm CT imaging, accurate table tracking is required in order to shift the virtual plan with the patient. If there are significant table tracking errors, the planned needle trajectory may deviate unacceptably from its actual position relative to the patient. These potential disadvantage—cumbersome table alignment and collision after table motion, as well as the risk of table tracking errors—have prompted the development of an alternative guidance method for percutaneous procedures involving C-arm fluoroscopic devices, including those that involve table motion.

### SUMMARY OF THE DISCLOSURE

A method for planning a percutaneous procedure is disclosed. The method may be for use in a system comprising an imaging system having a movable arm, an x-ray source and an x-ray detector and a display and a system controller connected to and in communication with the imaging system and display. The method may comprise (a) providing a three-dimensional image data set of a patient tissue region; (b) obtaining an x-ray image of the patient tissue region using the x-ray source and the x-ray detector; (c) co-registering the three-dimensional image data set to an x-ray image acquired using the imaging system; (d) obtaining target point data representative of a target object within the patient tissue region, and obtaining skin entry point data representative of a skin entry point, wherein the target point data and skin entry point data are obtained from one of: (i) the co-registered three dimensional image data set, and (ii) two x-ray views taken under different view orientations using a triangulation technique; (e) generating a line on the display, where the line intersects the target point and the skin entry point and defines a planned instrument trajectory; and (f) adjusting the movable arm to a position at which an x-ray image taken using the x-ray source and x-ray detector results in the target point and the skin entry point being superimposed on each other. Alignment of an instrument positioned between the x-ray source and the skin entry point may be verified as an acceptable position with respect to the planned instrument trajectory when the instrument appears on the display as a point overlying the target point and the skin entry point in a verification x-ray image taken using the x-ray source and x-ray detector.

A system for planning a percutaneous procedure is also disclosed. The system may comprise an imaging system having a movable arm, an x-ray source and an x-ray detector and a display and a system controller connected to and in communication with the imaging system and display, and a machine-readable storage medium encoded with a computer program code such that, when the computer program code is executed by a processor, the processor performs a method. The method performed by the processor may comprise: (a) obtaining a three-dimensional image data set of a patient tissue region; (b) obtaining an x-ray image of the patient tissue region using the x-ray source and the x-ray detector; (c) co-registering the three-dimensional image data set to an x-ray image acquired using the imaging system; (d) obtaining target point data representative of a target object within the patient tissue region, and obtaining skin entry point data representative of a skin entry point, wherein the target point data and skin entry point data are obtained from one of: (i) the co-registered three dimensional image data set, and (ii) two x-ray views taken under different view orientations using a triangulation technique; (e) generating a line on the display of the combined image, where the line intersects the target point and the skin entry point and defines a planned instrument trajectory; and (f) adjusting the movable arm to a position at which an x-ray image taken using the x-ray source and x-ray detector results in the target point and the skin entry point being superimposed on each other. Alignment of an instrument positioned between the x-ray source and the skin entry point may be verified as an acceptable position with respect to the planned instrument trajectory when the instrument appears on the display as a point overlying the target point and the skin entry point in a verification x-ray image taken using the x-ray source and x-ray detector.

A method for planning a percutaneous procedure is further disclosed. The method may be used in a system comprising an imaging system having a movable arm, an x-ray source and an x-ray detector and a display and a system controller connected to and in communication with the imaging system and display. The method may comprise: (a) obtaining a three-dimensional image data set of a patient tissue region; (b) obtaining an x-ray image of the patient tissue region using the x-ray source and the x-ray detector and displaying the x-ray image on a first portion of the display; (c) obtaining a multi-planar reformatting (MPR) view generated from the three-dimensional image data set and displaying the MPR view on a second portion of the display; (d) co-registering the three-dimensional image data set to the x-ray image and displaying the combined image on a third portion of the display; (e) displaying a three-dimensional rendering of the three-dimensional data set on a fourth portion of the display; (f) obtaining target point data from the combined image, the target point data representative of a target object within the patient tissue region; (g) obtaining skin entry point data from the combined image; (h) displaying the target point, the skin entry point, and a line connecting the two points on each of the x-ray image, the MPR view, the combined image, and the three-dimensional rendering on the display, where the line connecting the two points represents a planned instrument trajectory; and adjusting the movable arm to a position at which an x-ray image taken using the x-ray source and x-ray detector results in the target point and the skin entry point being superimposed on each other on at least one of the x-ray image, the MPR view, the combined image and the three-dimensional rendering on the display. Alignment of an instrument positioned between the x-ray source and the skin entry point may be verified as an acceptable position with respect to the planned instrument trajectory when the instrument appears on the display as a point overlying the target point and the skin entry point in a verification x-ray image taken using the x-ray source and x-ray detector.

### BRIEF DESCRIPTION OF THE DRAWINGS

The accompanying drawings illustrate preferred embodiments of the disclosed method so far devised for the practical application of the principles thereof, and in which:

FIG. 1 is a is a schematic diagram showing an x-ray imaging system for performing the disclosed method;

FIGS. 2A-2I are flow charts describing a sequence of steps of the disclosed method;

FIG. 3 is a display view of a three-dimensional rendering of a test phantom showing objects internal to the phantom that are representative of different types of patient tissue;

FIG. 4 is a display view of an exemplary soft key popup for accessing the disclosed system;

FIG. 5 is a display view showing fluoroscopic, multi-planar reformation (MPR) image and 3-dimensional rendering views of an exemplary phantom;

FIG. 6 is the display view of FIG. 5 with the addition of a saved fluoroscopic view of the exemplary phantom;

FIG. 7 is a display view similar to that of FIG. 5 with the addition of a second fluoroscopic view of the exemplary phantom;

FIG. 8 is a display view showing MPR views overlying the first and second fluoroscopic views;

FIG. 9 is a display view showing MPR views overlying the first and second fluoroscopic views in which targets within the MPR views are shown in high contrast;

FIG. 10 is a display view showing the selection of a target point on the first and second fluoroscopic views and the MPR view;

FIG. 11 is a display view showing the selection of a skin entry point on the first and second fluoroscopic views and the MPR view;

FIG. 12 is a schematic view of a SeeStar instrument placement device;

FIGS. 13A, 13B and 13C are views of a biopsy grid device, a CT scan of a patient on whom the biopsy mesh device has been placed, and a photograph of a biopsy mesh device positioned on a patient's skin;

FIG. 14 is a display view of a biopsy mesh device visible under a fluoroscopic view, with the selected target point identified within the mesh;

FIG. 15 is a display view showing a collimated fluoroscopic view of the target and skin entry points, as well as an oblique fluoroscopic view showing a planned path trajectory intersecting the target and skin entry points;

FIG. 16 is an enlarged view of the collimated fluoroscopic view of FIG. 15;

FIG. 17 is an enlarged view of the collimated fluoroscopic view of FIG. 15 showing an instrument inserted at the skin entry point;

FIG. 18 is a collimated fluoroscopic view taken oblique to the view of FIG. 17 showing the position of the instrument relative to the graphical overlay of the planned instrument trajectory;

FIG. 19 is a collimated fluoroscopic view taken oblique to the views of FIGS. 17 and 18 showing the position of the instrument relative to the graphical overlay of the planned instrument trajectory;

FIG. 20 is a collimated fluoroscopic view showing the position of the instrument as it intersects the target; and

FIG. 21 is a C-arm CT (DynaCT) scan of the completed instrument insertion.

### DETAILED DESCRIPTION

### Definitions

An “imaging system” is a system that includes at least a movable arm, an x-ray source, an x-ray detector, a display and a system controller. A “patient 3-dimensional image data set” is a three dimensional numerical array whose elements hold the values of specific physical properties at points in space inside the patient's body. A “multiplanar reformation image (MPR)” is a planar cross-section of the patient 3-dimensional image data set generated by cutting through the three-dimensional data set at some orientation (e.g., axial, coronal, sagittal, or oblique). A “fluoroscopic image” is a two-dimensional x-ray projection image showing internal tissues of a region of the body. A “live fluoroscopic image” is a sequence of x-ray images taken successively showing live movement of internal tissues of a region of the body. A “combined image” is an image in which an x-ray image is combined with an MPR or three-dimensional rendering of a three-dimensional data set. “Co-registering” means aligning an x-ray image with a patient 3-dimensional image data set such that associated features within the x-ray image and a two-dimensional overlay image generated from the patient 3-dimensional image data set appear at the same location on a display in which the x-ray image and the overlay image are shown together. Co-registration can be point-based or gray-level based. In point-based co-registration, a transform is applied to the 3-dimensional image data set such that points in the resulting overlay image line up with their counterparts in the x-ray image as closely as possible. Gray-level based co-registration techniques determine the transform not by minimizing the distance between associated points in the overlay image and x-ray image, but by minimizing an error metric based on the resulting overlay image's gray levels and the x-ray image's gray levels. “Instrument” refers to any object which may pierce tissue of a patient, a non-limiting listing of which include needles and other biopsy devices, screws, implants, cannula, endoscopes, and anything else that can be inserted into a patient's body either percutaneously or intravascularly. A “skin entry point” is the position on a patient's skin at which an instrument is inserted. “Skin entry point data” is data representative of the skin entry point within the patient 3-dimensional image data set or within two x-ray views taken under different view orientations using a triangulation technique. A “target” or “target point” is a point within the body of a patient that is the subject of a percutaneous procedure. “Target point data” is data representative of the skin entry point within the patient 3-dimensional image data set or within two x-ray views taken under different view orientations using a triangulation technique. A “planned path” is a line generated between the skin entry point and the target point. “Instrument trajectory” is a desired trajectory of the instrument defined by the planned path. A “Bull's Eye View” is an x-ray view under which a target point and another point along the instrument trajectory are projected onto each other. The other point along the instrument trajectory may be the skin entry point. The movable arm view direction can be visualized using a graphical overlay in which the target point and skin entry point, forward-projected from 3-dimensions to 2-dimensions, are displayed as individual circles. If the Bull's Eye View has been reached, these two circles are projected at the same 2-dimensional position (i.e., they appear concentrically aligned). A “progression view” is an x-ray image taken at an oblique angle with respect to a line joining the skin entry point and the target. movable arm tomographic reconstruction refers to a technique in which multiple x-ray images taken along a partial circle scan of the movable arm system are used to construct a patient 3-dimensional image data set.

A system and method are disclosed for providing a user with enhanced information regarding instrument positioning and guidance to a target within a patient's body as part of a percutaneous procedure. Using a patient 3-dimensional image data set (referred to hereinafter as a “3D volume”) the system and method enable the user to select a skin entry point and a target point within the patient. A line is generated between the skin entry point and the target point which is used to align the movable arm to achieve a “Bull's Eye View,” in which the two points are superimposed to show only a single point to the user. The instrument is placed at the skin entry point and aligned using the Bull's Eye View to orient the instrument along a desired instrument trajectory (i.e., one that hits both points). Initial alignment is verified using a fluoroscopic image of the oriented instrument. After the initial alignment is verified, the user inserts the instrument a short distance into the patient. One or more progression x-ray views are used to verify that the instrument is on the planned path between the skin entry point and the target point. The user may employ an iterative approach of inserting the instrument a small distance followed by a verification of the instrument's position using progression x-ray views to guide the instrument to the target. When the instrument reaches the target, a desired additional procedure may be performed, such as a biopsy, a drainage procedure, a radiofrequency ablation, or other medical interventional procedure.

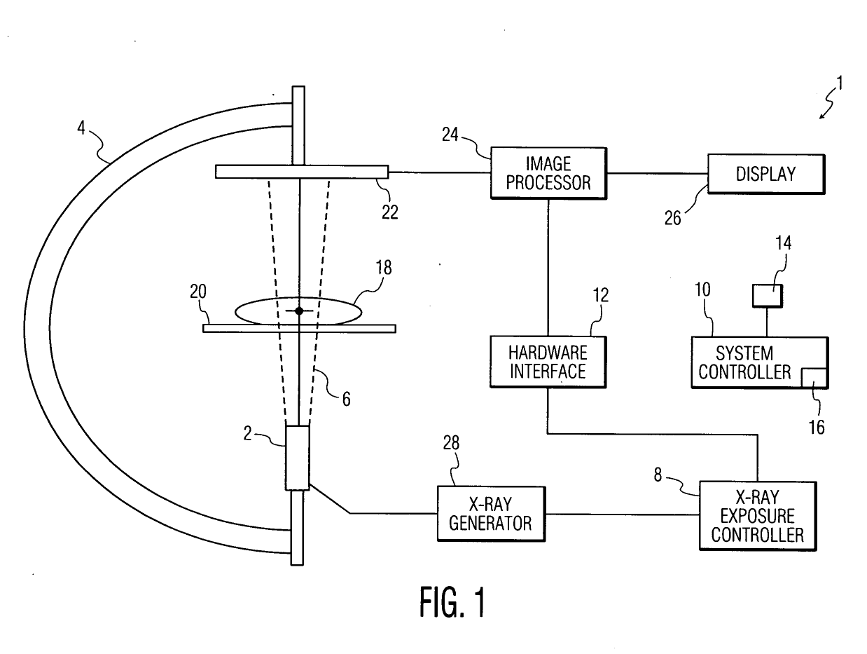

Referring to FIG. 1, an exemplary x-ray system 1 is shown for performing a percutaneous procedure. They x-ray system 1 may comprise an x-ray tube or source 2 and associated support and filtering components. The x-ray source may be affixed to a support, such as a movable arm 4 to allow the x-ray source to be moved within a constrained region. In one embodiment, the movable arm 4 is a C-arm. The constrained region may be arcuate or otherwise three dimensional, depending on the nature of the support structure. A collimator may also be included, which defines the size and shape of x-ray beam 6 emerging from the source. An x-ray exposure controller 8 and system controller 10 may also be included. System controller 10 may be a personal computer or any known controller capable of receiving and transmitting control signals to/from the above-described x-ray system components via a hardware interface 12. System controller 10 may include a user input device 14, such as a trackball, mouse, joystick, and/or computer keyboard to provide for user input in carrying out various system functions, such as mode selection, linearity control, x-ray dose control, data storage, etc. The system controller 10 may include a processor 16 executing instructions for performing one or more steps of the disclosed method.

In the illustrated embodiment, a patient 18 is shown on patient-support table 20 such that an X-ray beam 6 generated by the X-ray source passes through him/her onto a detector 22. In one embodiment the detector 22 is a flat panel detector that acquires digital image frames directly, which are transferred to an image processor 24. A display/record device 26 records and/displays the processed image(s). The display/record device 26 may include a display for displaying the displayed image output, as well as a separate device for archiving. The image is arranged for storage in an archive such as a network storage device. The X-ray source 2 is controlled by the system controller 10 via exposure controller 8 and X-ray generator 28. The position of the X-ray source 2 may be adjusted via a drive system associated with the movable arm 4. The movable arm 4, X-ray source 2, X-ray detector 22, display 26 and system controller 10 may together be referred to as an imaging system.

Workflow Steps

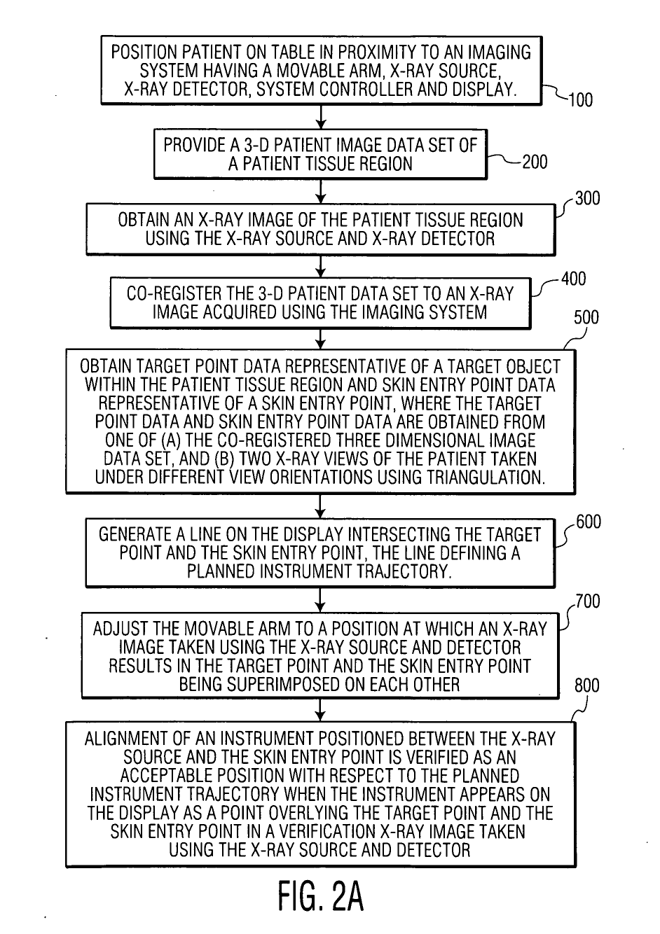

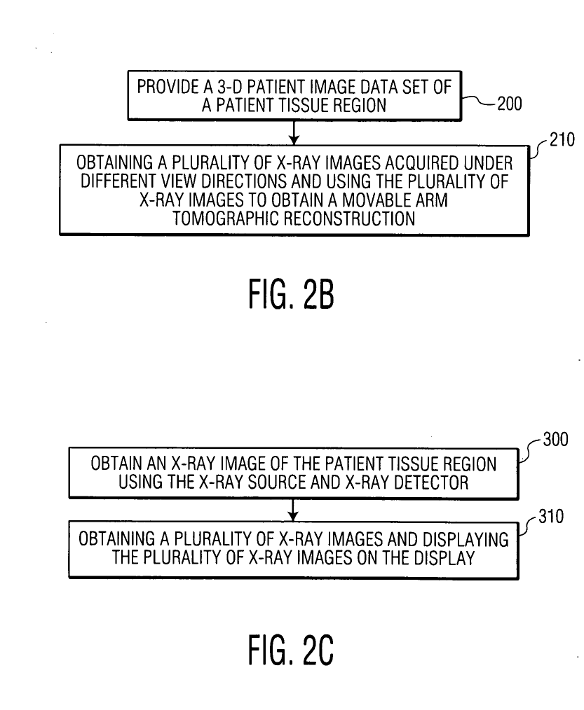

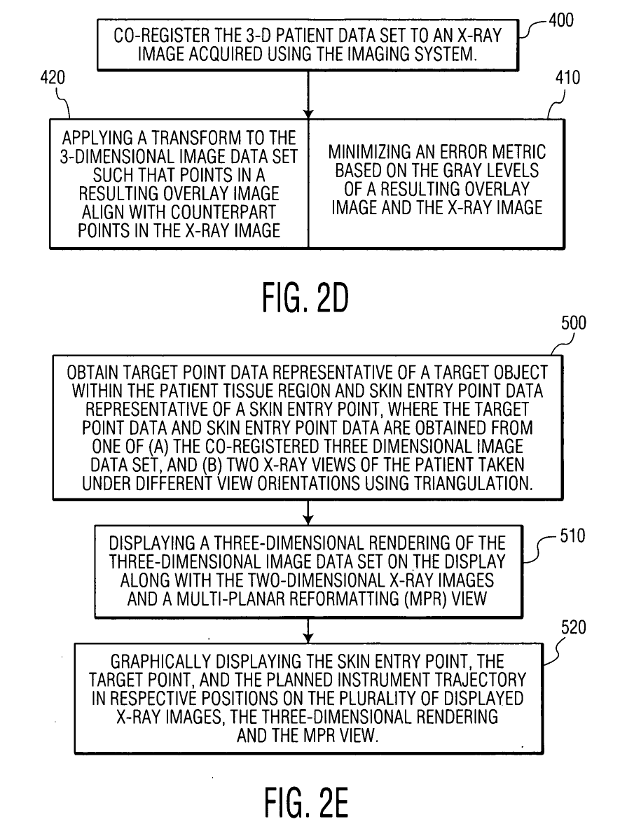

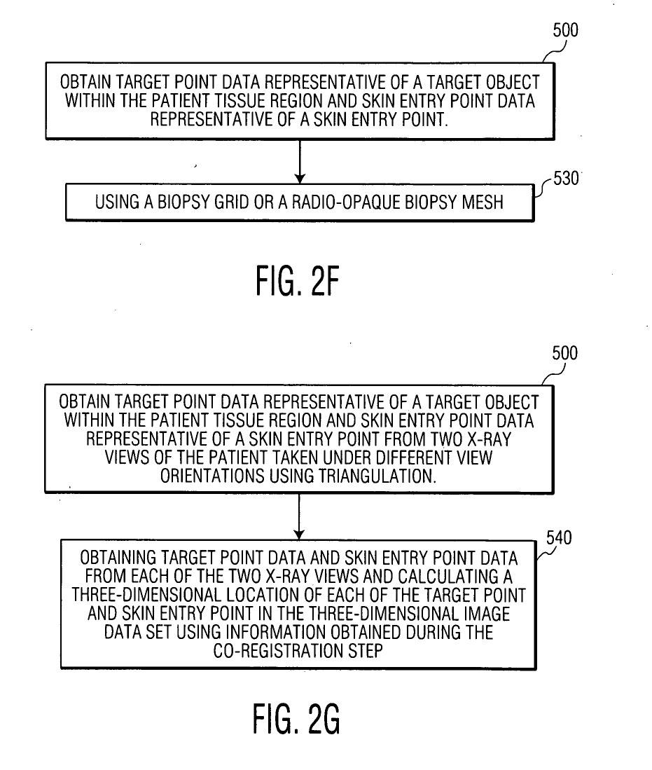

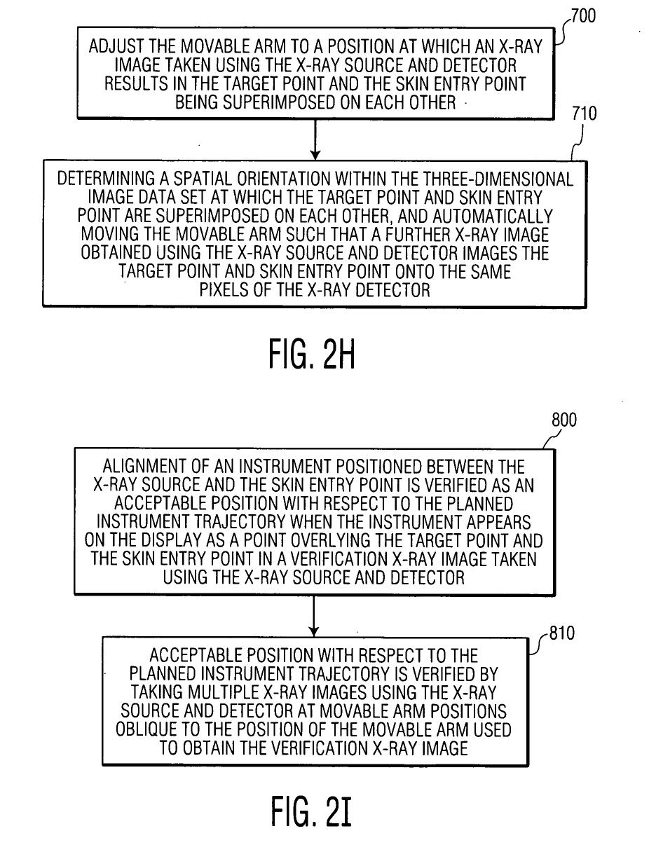

Referring to FIGS. 2A-2I, the disclosed method will be described in greater detail. At step 100, the patient 18 is positioned on the patient table 20 in proximity to an imaging system having a movable arm 4, source 2 and detector 22, system controller 10 and display 26. The system controller 10 is connected to the movable arm, the source 2, detector 22, and display 26. At step 200, a 3-dimensional image data set of a patient tissue region is obtained. This 3-dimensional image data set is employed by the user to identify the target of the percutaneous procedure (e.g., a tumor) and also to establish a trajectory and planned path for the instrument. The 3-dimensional image data set may be obtained using a variety of known image generating systems in which typical targets can be seen clearly. Examples of such systems include magnetic resonance imaging (MRI), Positron emission tomography (PET), computer tomography (CT x-ray), and movable arm CT (e.g., DynaCT). It will also be appreciated that if the target is visible under X-ray imaging, it may be possible to localize the target from multiple x-ray views using triangulation techniques. In one embodiment, shown at step 210 in FIG. 2B, the 3-dimensional image data set may be obtained by taking a plurality of x-ray images acquired under different view directions, and using the plurality of x-ray images to obtain a movable arm tomographic reconstruction.

At step 300, an x-ray image of the patient tissue region is obtained using the X-ray source 2 and X-ray detector 22. In one embodiment, shown at step 310 in FIG. 2C, a plurality of x-ray images are obtained and displayed on the display 26. At step 400, the 3-dimensional data set is co-registered to the x-ray image acquired using the source and detector. This registration step ensures that the fluoroscopic (x-ray) images of the patient obtained using the source 2 and detector 22 match the images of the patient constructed from the 3-dimensional data set. This enables instrument positioning using information on target position obtained from the 3-dimensional data set. In one embodiment, shown at step 410 in FIG. 2D, the co-registration step is performed by minimizing an error metric based on gray levels of a resulting overlay image and the x-ray image. In another embodiment, shown at step 420, the co-registration step is performed by applying a transform to the 3-dimensional image data set such that points in a resulting overlay image align with counterpart points in the x-ray image.

At step 500, the system obtains target point data representative of a target object within the patient tissue region. The system also obtains skin entry point data representative of a skin entry point. The target point data and the skin entry point data are obtained from one of (a) the co-registered three dimensional image data set, and (b) two x-ray views of the patient tissue region taken under different view orientations using triangulation. In one embodiment, shown at step 510 in FIG. 2E, a three-dimensional rendering of the three-dimensional image data set is displayed on the display 26 along with the two-dimensional x-ray images and an MPR view. At step 520, the skin entry point xₑ, target point xₜ, and the planned instrument trajectory “n” are graphically displayed in respective positions on the plurality of displayed x-ray images, the three-dimensional rendering, and the MPR view. Referring to FIG. 2F, a biopsy grid or a radio-opaque biopsy mesh can be used at step 530 as part of the process for obtaining target point data and skin entry point data. At step 540 (FIG. 2G), obtaining target point data and skin entry point data can be performed by obtaining target and skin entry point data from each of the two x-ray views and calculating a three-dimensional location of each of the target point and skin entry point in the three-dimensional image data set using information obtained during the co-registration step 400.

Referring again to FIG. 2A, at step 600, the system 1 generates a line on the display intersecting the target point xₜ and the skin entry point xₑ, where the line defines a planned instrument trajectory “n”. At step 700, the movable arm is adjusted to a position at which an x-ray image taken using the x-ray source and the x-ray detector results in the target point and the skin entry point being superimposed on top of each other. In one embodiment, the step of adjusting the movable arm may comprise determining a spatial orientation within the three-dimensional image data set at which the target point and skin entry point are superimposed on each other, and automatically moving the movable arm so that a further x-ray image obtained using the x-ray source 2 and detector 22 images the target and skin entry points onto the same pixels of the x-ray detector (step 710, FIG. 2H).

At step 800, alignment of an instrument positioned between the x-ray source 2 and the skin entry point is verified as an acceptable position with respect to the planned instrument trajectory when the instrument appears on the display as a point overlying the target point and the skin entry point in a verification x-ray image taken using the x-ray source and detector. In one embodiment, acceptable position with respect to the planned instrument trajectory is verified by taking multiple x-ray images using the x-ray source 2 and detector 22 at movable arm positions oblique to the position of the movable arm 4 used to obtain the verification x-ray image.

In further steps, the user may insert the instrument into the patient at the skin entry point. One or more progression x-ray views may be taken to ensure that the instrument remains aligned with the projected instrument path. It will be appreciated that the user may also return to the Bull's Eye View to gain additional insights regarding instrument orientation. The user may press the instrument further into the patient toward the target while making adjustments to ensure the instrument remains aligned with the projected instrument path. The pressing and progression x-ray steps may be repeated as desired by the user to guide the instrument in an incremental manner to intersect the target.

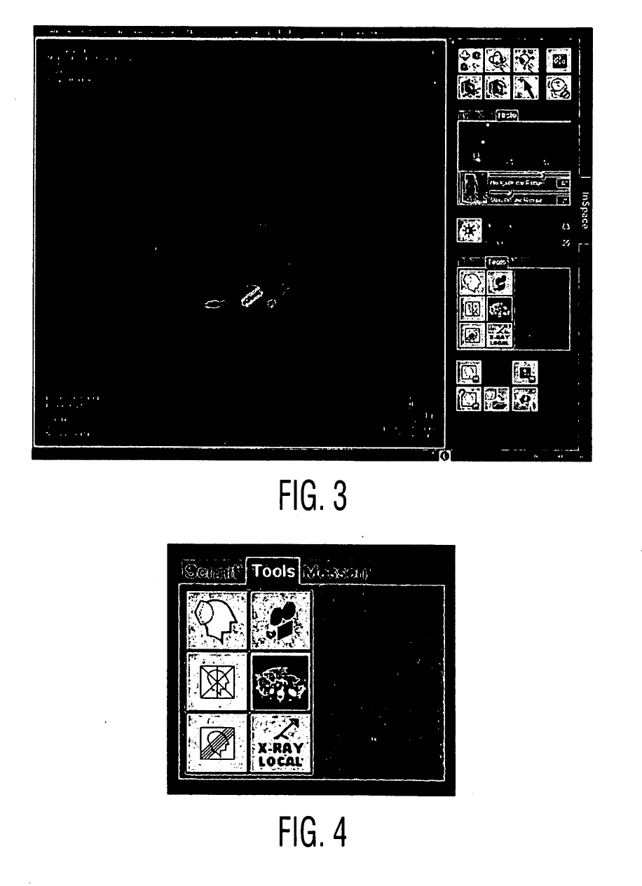

An exemplary embodiment of the disclosed system and method will now be described in relation to a series of graphical screen displays which show the detailed implementation of the system. FIG. 3 shows a 3-dimensional rendering of a 3-dimensional data set that has been loaded into an appropriate rendering program, such as the Siemens InSpace system, for viewing (the figures show 3-dimensional images representative of test phantoms that have a plurality of objects placed inside to simulate vessels, landmarks and targets). It will be appreciated that although the InSpace system was used to generate the illustrated images, a variety of such display/rendering systems may also be used to implement the disclosed system and method. To engage the instrument guidance system, an appropriate soft key (labeled “X-RAY LOCAL” in FIG. 4) may be provided.

Initially, it will be appreciated that the x-ray views (fluoroscopic images) obtained using the movable arm, source 2 and detector 22, needs to be appropriately “registered” with the MPR images derived from the 3-dimensional data set of the region of interest of the patient. Data registration may be performed manually, automatically or semi-automatically (i.e., computer assisted).

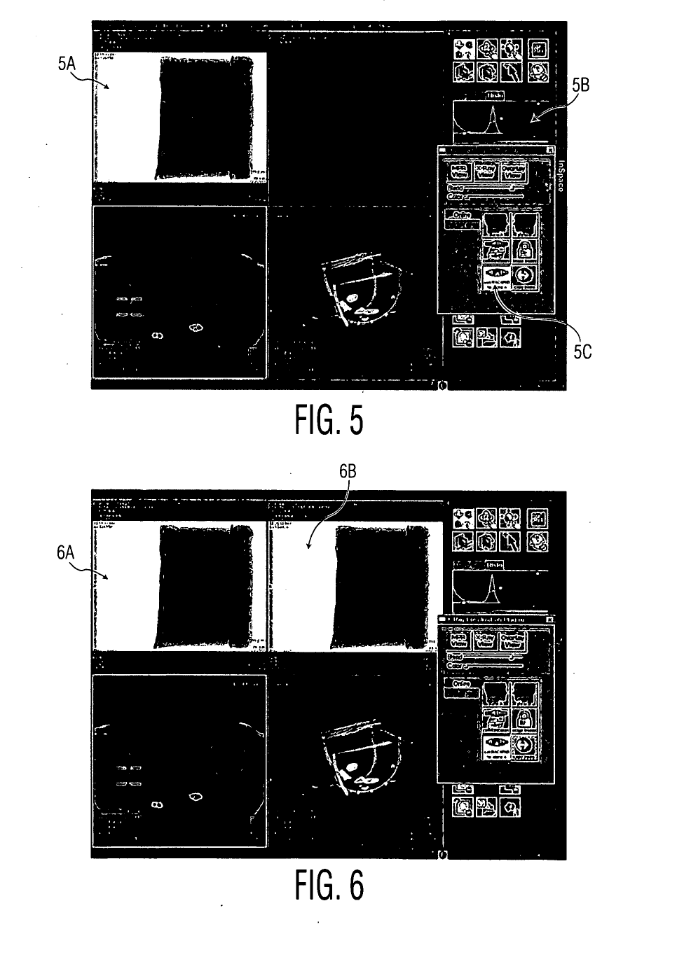

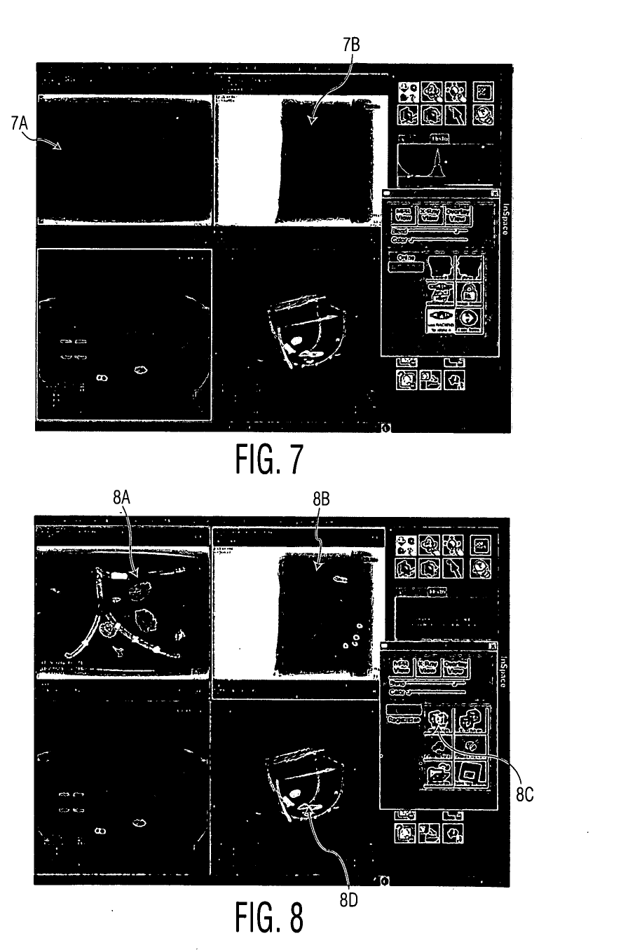

In one exemplary embodiment of a manual registration technique, movable arm x-ray views may be set up to aid in the registration of the movable arm x-rays with 3-dimensional data sets that have been previously obtained. Thus, the user may initially place the movable arm into an oblique or lateral view with respect to the patient 18 before taking an x-ray. Referring to FIG. 5, an exemplary oblique x-ray view is shown in display quadrant 5A. This “current” x-ray image in display quadrant 5A may be stored together with the associated projection geometry (shown graphically as item 5B on a side-bar of the display). This may be achieved by pressing an appropriate soft-key 5C provided on a pop-up window on the display. The x-ray image appears in display quadrant 6A as the “current” image, and also appears in display quadrant 6B as the stored x-ray image, as shown in FIG. 6. An oblique or orthogonal x-ray view may also be obtained, providing another view from a different orientation. In the illustrated embodiment this orthogonal view has been taken in a position such that the x-ray source 2 is positioned directly under the patient table 20. The resulting x-ray image is shown in display quadrant 7A of FIG. 7 (note the stored x-ray image appears in display quadrant 7B, and is the same as the stored image that appeared in display quadrant 6B of FIG. 6). Once two orthogonal x-ray views are obtained and positioned side by side on the display (quadrants 7A and 7B), the 3-dimensional dataset may be registered to the 2-dimensional X-ray images. Referring to FIG. 8, respective overlay images computed from the 3-dimensional image data set are overlaid on the x-ray images, as shown in display quadrants 8A, 8B. To verify that the 3-dimensional image data set is registered to the x-ray images, the user can review the superimposed images to determine whether respective internal features (i.e., landmarks) match. Image overlay involves the fluoroscopic image and a 2-dimensional overlay image generated from the 3-dimensional patient image data set. Standard rendering techniques can be used to arrive at a 2-dimensional overlay image generated from a 3-dimensional data set. In an x-ray setup, so-called digitally reconstructed radiographs are well-known as a means to compute overlay images. Once a 2-dimensional overlay image has been computed, it can be combined with the fluoroscopic image, for example, using standard image blending techniques.

If the user detects mis-registration between the x-ray images and the respective overlay image, manual registration of the 3-dimensional data set with 2-dimensional x-ray images can be performed. To this end, shift and rotation may be adjusted. An intuitive way to arrive at the rotation involves the use of a “pivot point,” which is a point around which the 3-dimensional data set can be rotated either before, or preferably after, shifting the 3-dimensional data set to align the associated 2-dimensional overlay image with the fluoroscopic image in the x-ray views (display quadrants 8A and 8B). In one exemplary embodiment, a “pivot point” may be a landmark, such as a bone, visible vessel, or other visually distinctive point of reference within the 3-dimensional patient data set (including MPRs obtained by putting cut-planes through the patient data set) and the x-ray images. Once such a pivot point has been identified, the 2-dimensional overlay image (computed by forward projecting of the 3-dimensional data rendered in display quadrant 8D along the movable arm view direction) may be manually shifted in one or more directions to align the pivot points. This shifting can be performed using a key-stroke, track-ball, mouse input, or other input device. If rotational misalignment exists between the two data sets, it can be eliminated by rotating the 3-dimensional data set around the pivot point while displaying the resulting 2-dimensional overlay views over the 2-dimensional x-ray views. Again, this may be performed using one of the manual input devices discussed.

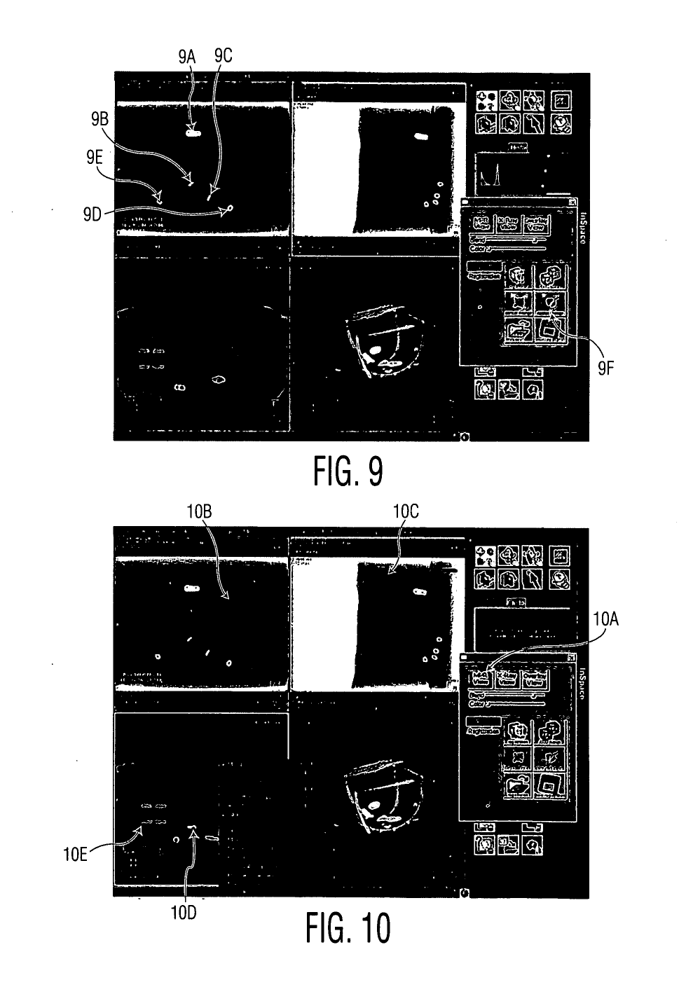

The manual registration process may be started by pressing an appropriate soft key 8C in the “Registration” pop-up tab card. In FIG. 9, appropriate window/level settings for the overlay images have been changed to reveal high contrast objects 9A-9E within the overlay image that may be used for registration as “fiducial markers.” Once the markers are aligned, an “accept change” soft key 9F may be actuated to store the registration result so that future superimpositions of fluoroscopic images and overlay views are appropriately registered. A selected fiducial marker can be used as a “pivot point.”

It will be appreciated that the aforementioned manual registration technique is only one method for registering the 3-dimensional data set to the live x-ray image(s), and others may also be used. Further, if the 3-dimensional data set is obtained using movable arm CT image acquisition just prior to performance of the percutaneous procedure, a registration step may not be required, since it is possible to keep the patient from moving in the time period between the CT-image acquisition procedure and the percutaneous procedure.

Once the 3-dimensional data set is appropriately registered to the 2-dimensional x-ray geometry, the instrument trajectory may be planned. To this end, the user may select a target point, xₜ, and a skin entry point, xₑ within the overlay images by visualizing the areas within a particular MPR and clicking on the point(s) using a selector such as a mouse button.

As shown in FIG. 10, this is done by selecting a desired MPR view, such as by a right-click of a mouse pointer on an appropriate soft key 10A in a pop-up window in the display. In the illustrated embodiment, this results in desired MPR views being displayed in the upper left quadrant 10B, and upper right quadrant 10C. The target point is “selected” by clicking with a mouse pointer at the target position 10D in the lower left quadrant MPR display 10E. The skin entry point may be selected (“clicked”) in the same manner.

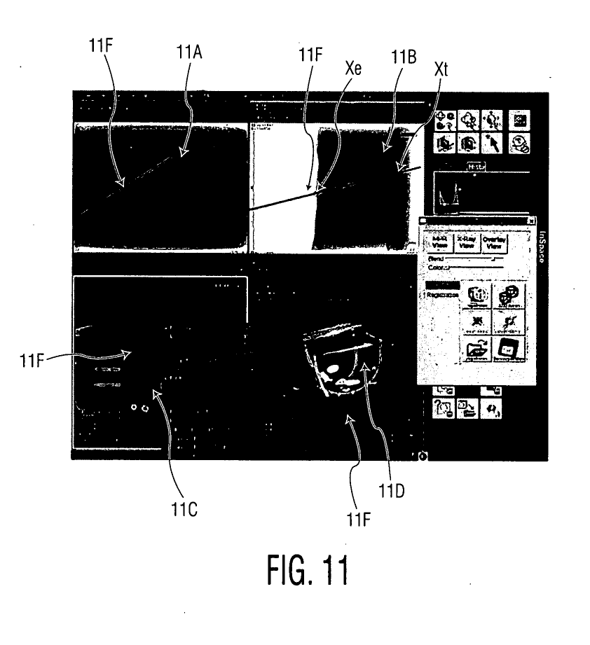

Based on where the click points are made in the MPR view, the system obtains data representative of the target and skin entry points using data from the 3-dimensional patient data set. Using the target point data and skin entry point data, the system generates a graphical overlay showing a line which represents the planned instrument trajectory. Such a graphical overlay is applied to each of the images shown on the user display (as seen as line 11F in FIG. 11). This graphical overly may consist of the target and skin entry points, as well as a line intersecting the two, and may be overlaid onto one or more of the display views (e.g., x-ray, MPR, 3-dimensional rendering) as desired by the user. Since the x-ray views and the patient 3-dimensional image data set are registered with one another at this point in the procedure, the system can map the exact location of the target point xₜ, and the skin entry point xₑ (as well as the connecting vector “n”) at their precise locations on each of the display views. As will be described in greater detail later, the displayed line represents the desired instrument path.

As an alternative to visualizing and selecting target and skin entry points using a particular MPR view, the user may instead obtain the location of the target point and skin entry point using x-ray images that have been successively obtained using mono-plane or bi-plane x-ray devices shooting at multiple oblique angles. The selection of target point xₜ and skin entry point xₑ is selected in a similar manner to the way these points are selected in the MPR view(s) as previously described. The user employs a mouse or other selection device to “click” on each selected point in the two x-ray images (i.e., one from each direction). The system obtains data representative of the target and skin entry points as described previously. Based on the target and skin entry point data the system generates a graphical overlay consisting of the three-dimensional target point xₜ, the skin entry point xₑ (as well as the connecting vector “n”) at their precise locations in the corresponding MPR view and/or three-dimensional rendering view.

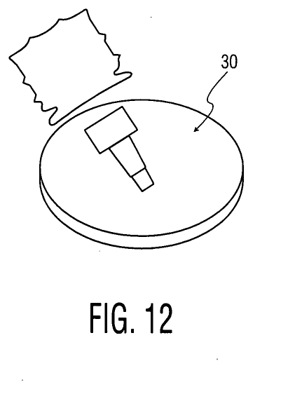

In one embodiment, a needle guidance device 30 (e.g., a SeeStar device, manufactured by Radi Medical Devices, Uppsala, Sweden) may be used to aid in planning an instrument insertion trajectory. The SeeStar device (see FIG. 12) consists of an instrument guide that produces an elongated artifact in an x-ray image. This elongated artifact indicates the trajectory of an instrument inserted through the SeeStar, and thus it can be determined whether the selected trajectory will intersect the target as desired.

As an alternative to a SeeStar device, the user may instead employ an elongated metal marker that shows up in an x-ray image to allow the user to verify the trajectory as acceptable using either 3-dimensional image rendering or by using two angularly offset X-ray views. Defining a skin entry point by localizing an instrument guidance device such as the SeeStar 30 may be particularly beneficial when using bi-plane x-ray devices in which both offset x-ray views are acquired simultaneously. In such a case, on-line re-planning can be performed to allow the user to adjust the instrument trajectory. The re-adjusted position may be quickly verified in the two bi-plane x-ray views.

If using an instrument guidance device other than a SeeStar 30, the guidance device can be oriented under a Bull's Eye View orientation such that the guidance device is projected directly onto the skin entry point and the target point. Once a desired position is achieved, the guidance device can be clamped into the Bull's Eye View position to guide the instrument into the soft tissue below.

As shown in the four display quadrants 11A, 11B, 11C and 11D of FIG. 11, the skin entry point xₑ and the target point xₜ define a line 11F (shown in 4 places) in 3-dimensional space having a path vector (n=xₑ-xₜ). It will be appreciated that, as an alternative to defining the path vector using two points in space, the trajectory could instead be defined using xₜ and the path vector “n”. This may be appropriate, for example, in the case where the patient is large and the skin entry point can not be seen in the movable arm CT (i.e., it is outside the physical range of the movable arm CT). In such a case, the user may not need to see the exact location of the skin entry point if there are no organs in the immediate area (e.g., where there is only fat tissue). Whether this is indeed the case or not can be checked if the registered 3-dimensional patient data set comprises the complete volume of the patient or if there is another 3-dimensional data set (e.g., CT, MRI) that provides similar information in outer patient regions. In such a case, the physician may simply “click” the desired target point xₜ in the appropriate display view(s), and may “click” a second point that is visible in the movable arm CT to define a desired path vector n without specifying an actual skin entry point xₑ. A desired instrument trajectory is a straight line (path vector) “n” that originates outside the patient's body and passes through the skin entry point xₑ and the target point xₜ without crossing bones or vital organs.

Once the skin entry point and target point have been selected, a verification step may be performed to ensure that the planned instrument trajectory is achievable (i.e., that the movable arm can be physically positioned in the planned Bull's Eye View position). Additionally, the system performs a check to ensure that the movable arm does not interfere with the patient table 20, the patient 18, or the user. These checks can be implemented by providing the system with a pre-determined range of impermissible positions, and verifying that the selected position (corresponding with the planned procedure path), is not within that range.

Thus, the system determines whether the movable arm 4 can be mechanically driven into the Bull's Eye View position (i.e., the position in which the instrument trajectory projects onto the display 22 as a single point rather than a line) and that the instrument trajectory can be seen on the detector 22 using the x-ray source 2. In the illustrated case, the Bull's eye view position requires that the source be located such that xₜ and xₑ are projected onto the same detector (pixel) position.

In addition, the system may also perform a verification step to ensure that the projections of xₜ and xₑ are captured by the active field of view of the detector 22. For a quick check on the feasibility of the x-ray source 2 position under the planned Bull's Eye View orientation, the intersection point, xₛ, of the needle trajectory and the “source sphere” can be computed. The “source sphere” is the set of possible X-ray source locations that are a particular distance away from the iso-center of the movable arm. Some variations in the “source sphere” can be taken into consideration by resorting to mechanical and image calibration information. The intersection of the path vector “n” with the source sphere determines two potential X-ray source positions under which the

Bull's eye view is obtained. The preferred location is the one that puts the X-ray source underneath the patient table to minimize radiation exposure to the eyes of the patient and user.

Thus, with the source located at xₛ, an ideal projection matrix may be computed taking the source-to-image distance (SID) and zoom factor into account. This is possible since both intrinsic and extrinsic source/detector parameters are known. Using this projection matrix, the locations at which xₑ and xₜ project onto the detector 22 are determined. If the instrument path connecting xₑ and xₜ projects outside of the detector area (or if the source 2 cannot be driven into this position xₛ), the system may provide a warning to prompt the user to change the instrument trajectory.

Once the aforementioned verification steps are performed and an acceptable instrument trajectory has been planned, the movable arm may be moved into the Bull's Eye View position. As previously noted, the Bull's Eye View orientation is one in which the skin entry point and the target point (xₑ and xₜ) overlie each other on the same detector positions xₑ′ and xₜ′, respectively. Adjustment of the movable arm 4 to achieve this positioning can either be performed manually or automatically.

For manual movable arm adjustment, the user may be graphically guided (using the display) to drive the system into a position at which xₑ and xₜ are projected onto each other, i.e., where xₜ′=xₑ′. During manual adjustment of the movable arm, a graphical overlay (FIG. 11) can be continuously updated to show where xₜ and xₑ are projected while the movable arm 4 moves. To enhance visual guidance, the graphical overlay may change its appearance when the movable arm 4 system approaches Bull's eye view conditions, i.e., when the projections of xₜ and xₑ approach each other. For example, circles centered at xₜ′ and xₑ′ may become larger when the movable arm 4 approaches the Bull's eye view position. Manual adjustment of the movable arm reaches its final arm position (the Bull's Eye View) when the projections of xₜ and xₑ overlap.

As shown in FIG. 11, the graphical overlay (i.e., the one in which points xₜ and xₑ are shown along with the line connecting them) may be combined with an anatomical image (i.e., an MPR view). In addition, the graphical overlay may be combined with both the forward projected anatomical image (overlay image) and live x-ray views. In the final movable arm position (again, the Bull's Eye View position), the graphical overlay may also adjust to different x-ray zoom conditions so that the user may confirm final positioning by revealing small deviations from the optimal view orientation. This resizing is automatically achieved through the use of a calculated conversion factor determined e.g., using a “similar triangles” technique.

In lieu of manual movable arm positioning, the system may perform an automatic Bull's Eye View positioning of the movable arm 4. In the automatic mode, the intersection of instrument trajectory with the source hemisphere may be determined by the system before the x-ray source 2 is automatically driven to that location, as previously discussed. To this end, the system may include a feedback-loop in which the movable arm 4 is driven automatically while continually comparing the locations of the detector points xₜ′ and xₑ′ of the target point and skin entry point, respectively. In this manner, the system may move the movable arm in a direction that minimizes the distance between xₜ′ and xₑ′, with the result being that the movable arm is driven to a position in which the detector points overlap (xₜ′=xₑ′). Once the Bull's Eye View position is achieved, the instrument may be positioned on the skin entry point xₑ.

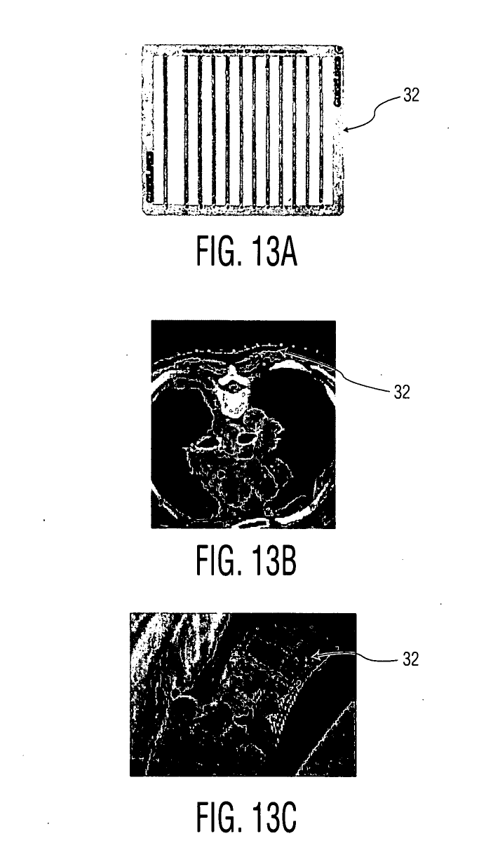

In practice, positioning an instrument at the skin entry point xₑ may be a difficult task, and thus a positioning aide may be used. If the user has access to a CT scanner equipped with a laser, a biopsy grid 32 (FIG. 13A) may be used as the positioning aide. The biopsy grid 32 may be placed on the patient's skin in the region of the proposed skin entry point xₑ and a movable arm CT process used to create the three-dimensional data set as previously described. As can be seen in FIG. 13B, the biopsy grid 32 shows up as a series of surface points in a CT scan of the patient. The skin entry point xₑ can be determined by selecting the proper CT slice position and the preferred entry point between the lines of the biopsy grid 32 (see FIG. 13C).

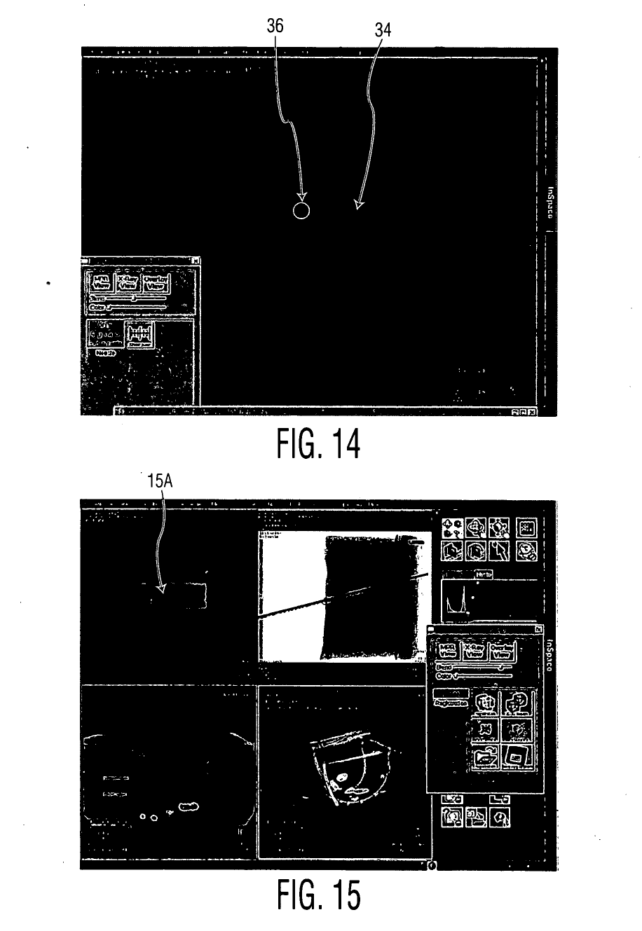

Alternatively, where simple fluoroscopic (x-ray) equipment is being used to guide the percutaneous procedure, a radio-opaque biopsy mesh 34 (FIG. 14) may be used as the positioning aide. Thus, the radio-opaque biopsy mesh 34 may be placed on the patient's skin in the region of the proposed skin entry point xₑ, and an x-ray image may be obtained using the source 2 and detector 22. The location on the biopsy grid 34 at which the target point xₜ and skin entry point xₑ coincide (shown as circle 36), is taken as the skin entry point, and the instrument may be located at that position on the grid 34. In the illustrated embodiment, the point at which the circle 36 resides on the grid is at a position four rows from the left and five rows up from the bottom. The user can place the tip of the instrument at that position on the grid 34. Additional x-rays may be obtained to fine tune the exact position of the instrument at the chosen grid location, and to align the instrument such that it is projected onto the point defined by the circle 36. Thus, acceptable instrument positioning and alignment are achieved when the instrument shows up in an x-ray view as a point superimposed on the overlapping circle 36.

The biopsy mesh 34 may be made out of a thin adhesive support material with embedded radio-opaque markers to facilitate easy cell identification. In one embodiment, radio-opaque numbers may be placed at the center of each “cell” center such as “(2,2)” to designate the second cell in the second row. In this way, the mesh may be easily visualized under collimated conditions.

Once the appropriate instrument positioning has been achieved, collimation may be set around the Bull's Eye View to limit radiation exposure to the user and patient. In one embodiment, “auto collimation” may be performed in which an asymmetric collimator is set to block radiation outside a rectangle that has xₜ′ and xₑ′ as center points (for a Bull's Eye View positioning). Collimated views are shown in display quadrant 15A in FIG. 15, and in the full screen display view of FIG. 16. As shown in the display quadrant 15A of FIG. 15, the movable arm has been driven into the Bull's Eye View position suggested by the system software in the manner previously discussed (i.e., by driving the movable arm in a direction that seeks to decrease the distance between xₜ′ and xₑ′ until they overlap on the same display pixel(s)), and the collimators have been driven in to minimize x-ray radiation.

The Bull's Eye View may be isolated and enlarged, as shown in FIG. 16, to reveal slight deviations from the desired instrument positioning and orientation. Thus, FIG. 16 shows a switch from the four-quadrant view of FIG. 15 to a full-window view with an increased zoom level to reveal deviations from the ideal Bull's Eye View.

As can be seen, the zoomed view of FIG. 16 shows concentric overlapping circles 38 (in black), 40 (in white) indicating that the Bull's Eye View has been achieved. In the illustrated embodiment, a SeeStar device has been used to aid instrument positioning. The SeeStar shows up as a circle 42 (i.e., a black tube-like shadow in the figure) in the center of the displayed circles, which indicates that it is in the desired orientation (i.e., one that is in alignment with a trajectory that passes through the skin entry point and the target point). If the SeeStar were to show up as a line, its position/orientation would be adjusted, followed by re-verification of the new position/orientation by subsequent x-ray views.

As previously noted, in lieu of a SeeStar device, the user could instead use a hollow instrument guide to verify instrument placement. The hollow instrument guide may be configured so that it shows up as a point under fluoroscopy in the Bull's Eye View when a desired alignment is achieved. The hollow instrument guide may be clamped in position during fluoroscopy to limit radiation to the user, and its position may be adjusted and verified in a manner similar to that described in relation to the SeeStar device.

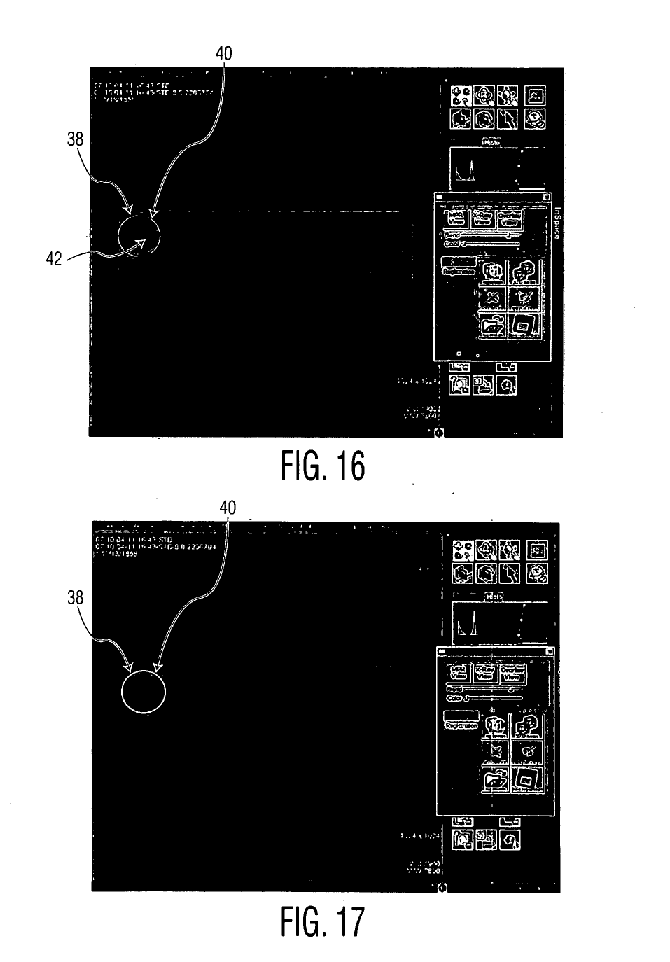

Once the desired instrument alignment is achieved, the instrument is pushed forward by a small amount into the patient tissue to stabilize the instrument's orientation. This insertion is performed under the Bull's Eye View. As shown in FIG. 17, the user can see straight down the instrument guide as well. The large circle represents the instrument body and instrument tip. In the illustrated embodiment they are exactly aligned, which is why only one large circle is visible in the figure. The black “bulb” in the center is the instrument (in the illustrated case, a needle). It appears in this way because it is almost (but not perfectly) aligned with the viewing direction. If the instrument were perfectly aligned, it would be shown as a circle in this view.

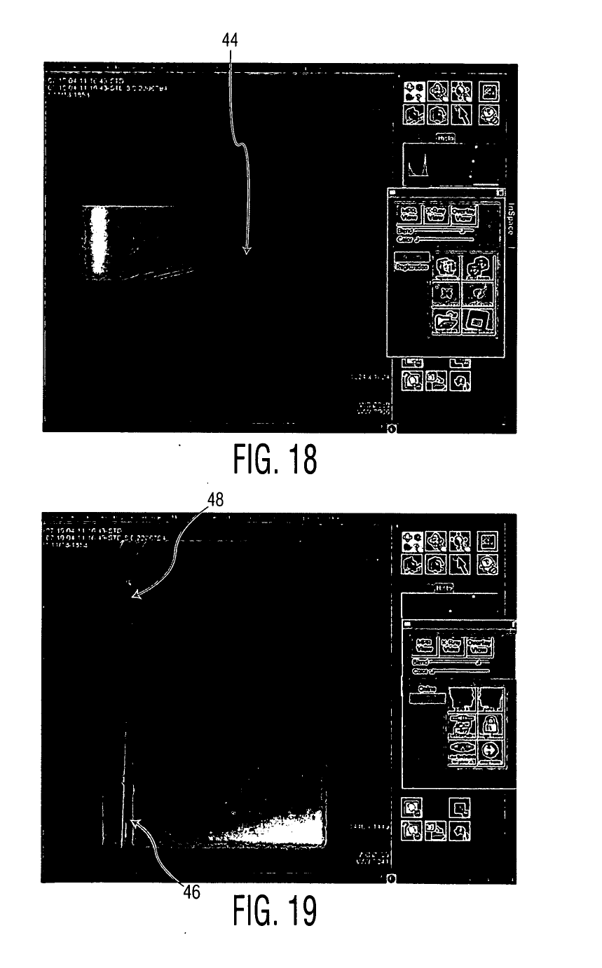

Instrument alignment may again be verified at this early stage of insertion. Such verification can be performed using x-ray “progression views,” which are oblique x-ray views (i.e., non-Bull's Eye Views) obtained using the source 2 and detector 22. It will be appreciated that the user may also return to the Bull's Eye View at any time during the procedure to obtain additional information regarding instrument alignment. If a bi-plane x-ray device is available with the B-plane providing a progression, it is possible to check if the instrument remains aligned with the associated graphical overlay (shown as line 44 in FIG. 18) while the instrument is being pushed forward into the tissue. In the illustrated embodiment, the instrument appears as a thin diagonal line starting from the bottom left of the image, just above the graphical overlay line 44.

The movable arm 4 may be rotated back and forth between two different progression views, one which is collimated around the instrument path, and a second in which a lateral view shows the instrument moving toward the target. It will be appreciated that the user may return to the Bull's Eye View for additional orientation information. In one embodiment, a first progression view (FIG. 18) is obtained by keeping the movable arm's cranial/caudal (CRAN/CAUD) angulation fixed while the movable arm's left anterior oblique/right anterior oblique (LAO/RAO) angle is changed relative to the Bull's Eye View position, e.g., by 40 degrees. The CRAN/CAUD and LAO/RAO angles identify the position of the movable arm in space, and thus they also define the direction in which x-rays are projected from the x-ray source 2. The aforementioned rotation is performed to ensure that the x-ray source 2 is maintained below the patient table 20 to limit radiation to the eyes of the patient and user. A second progression view (FIG. 19) defined as being oblique to the Bull's Eye View in the CRAN/CAUD direction with the primary LAO/RAO angle kept constant. In the illustrated case, the maximum possible secondary movable arm angle that just avoids collision with the patient table 20 is used. This puts the second progression view at LAO/RAO=−21.70 and CRAN/CAUD=43.00. It will be appreciated that these progression views are merely exemplary, and other appropriate progression positions may be used.

During the procedure, the movable arm 4 may be moved between the first and second progression views to enable the user to control the actual instrument movement from two oblique angles until the instrument has reached the target. When the target has been almost reached in one progression view, the user can return to the other progression view to confirm that the instrument has indeed been placed correctly before making the final push or releasing a spring-loaded biopsy device if one is used. The user can also return to the Bull's Eye View to obtain additional orientation information.

Under each progression view, as well as under the Bull's Eye View, collimators may be placed to both sides of the instrument path before x-rays are released. Collimator placement may be controlled manually or automatically (“auto-collimation”). If auto-collimation is used, it may be performed such that xₜ′ and xₑ′ shown in the progression views reside at the corner points of an inner rectangle (see, e.g., FIG. 18) with collimators placed around on the outside so as to ensure that the points (xₜ′, xₑ′) are visible while minimizing the total area of exposure. Other “auto collimation” constraints may also be used, such as using a small square placed somewhere along the line connecting xₜ′ and xₑ′. If the instrument tip is tracked, a collimation area may be defined with the instrument tip at its center following it. In the illustrated embodiments, a symmetric collimator was used that can only collimate around the center of the detector 22. For more flexibility, an asymmetric collimator may be used.

Referring again to FIG. 19, the movable arm is moved into the second progression view to check on instrument placement. If instrument 46 and graphical trajectory 48 align, the instrument 46 can be moved into the target. In the illustrated embodiment, a small degree of bend is shown in the instrument 46, which can occur when the instrument is small/thin and the target is dense.

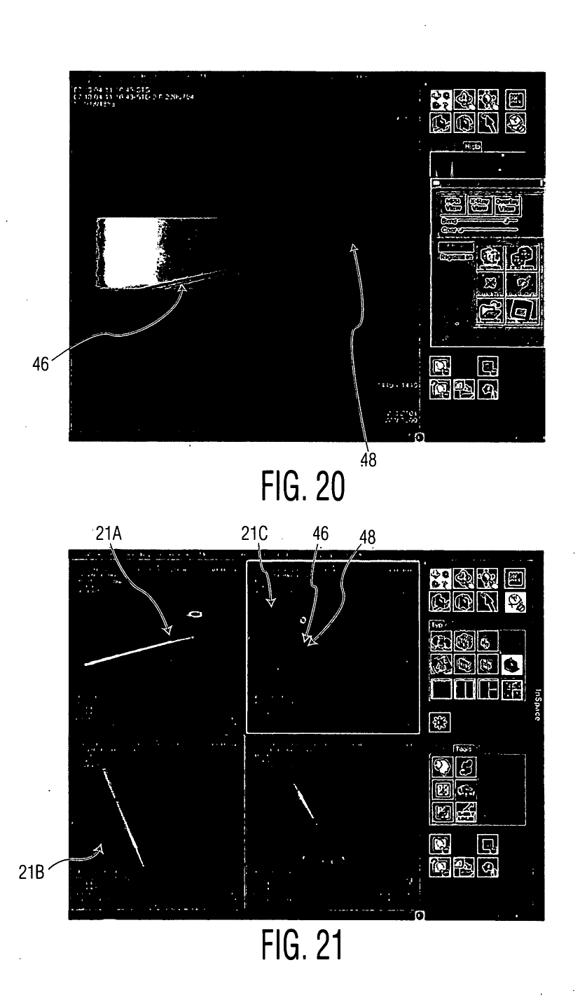

Referring to FIG. 20, a return to the first progression view is performed to confirm instrument placement at the target. It will be appreciated that if a bi-plane fluoroscopic device is available, there is no need to rotate the movable arm's A-plane back and forth between two progression views. Instead, the A-plane can be put at the first progression view while the B-plane is positioned under the second progression view, and both may be viewed simultaneously As an alternative to the use of progression views to verify instrument positioning during insertion, movable arm CT (DynaCT) acquisitions can be performed throughout the workflow to verify the instrument position and orientation at each stage of insertion. Such a movable arm CT acquisition can be performed at one or more stages of the procedure, as desired by the user. It is noted, however, that the movable arm CT procedure can take up to several minutes and increases the overall amount of radiation exposure to the patient. Progression views, by contrast, are relatively fast (almost instantaneous). The user simply rotates the movable arm (if required) to the desired progression view location, and releases the x-rays. The x-ray image shows up on the display in a few seconds.

FIG. 21 shows a movable arm CT (DynaCT) scan of the completed instrument insertion position. Although not required, performing such a verification ensures that the positioning is correct prior to completing the procedure. As can be seen in the MPR views shown in the upper and lower left quadrants 21A, 21B of FIG. 21, the instrument 46 has been appropriately engaged with the target 48. The upper right quadrant view (which shows the Bull's Eye View), however, reveals that the instrument 46 just made it into the target 48.

From experiments performed on static phantoms, the inventors estimate that the size of a spherical static target 48 that can be successfully engaged under double-oblique conditions (the aforementioned progression views) is about 1 centimeter.

In practice, an asymmetric collimator is preferable to limit radiation to a minimum by establishing a tight collimation around the instrument path. If, however, only a symmetric collimator is available that blocks x-rays symmetrically around the central ray of the x-ray cone, table motion may be required to enable a tight collimation around the instrument trajectory. In such a case, the disclosed method still provides the benefit in that it does not require an exact alignment of the central ray of the source 2 and the instrument 46 trajectory.

The method described herein may be automated by, for example, tangibly embodying a program of instructions upon a computer readable storage media capable of being read by machine capable of executing the instructions. A general purpose computer is one example of such a machine. A non-limiting exemplary list of appropriate storage media well known in the art would include such devices as a readable or writeable CD, flash memory chips (e.g., thumb drives), various magnetic storage media, and the like.

The features of the method have been disclosed, and further variations will be apparent to persons skilled in the art. All such variations are considered to be within the scope of the appended claims. Reference should be made to the appended claims, rather than the foregoing specification, as indicating the true scope of the disclosed method.

The functions and process steps herein may be performed automatically or wholly or partially in response to user command. An activity (including a step) performed automatically is performed in response to executable instruction or device operation without user direct initiation of the activity.

The systems and processes of FIGS. 1-21 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The processes and applications may, in alternative embodiments, be located on one or more (e.g., distributed) processing devices accessing a network linking the elements of FIG. 1. Further, any of the functions and steps provided in FIGS. 2-21 may be implemented in hardware, software or a combination of both and may reside on one or more processing devices located at any location of a network linking the elements of FIG. 1 or another linked network, including the Internet.

1. A method for planning a percutaneous procedure for use in a system comprising an imaging system having a movable arm, an x-ray source and an x-ray detector and a display and a system controller connected to and in communication with the imaging system and display, comprising:
providing a three-dimensional image data set of a patient tissue region;
obtaining an x-ray image of the patient tissue region using the x-ray source and the x-ray detector;
co-registering the three-dimensional image data set to an x-ray image acquired using the imaging system;
obtaining target point data representative of a target point within the patient tissue region, and obtaining skin entry point data representative of a skin entry point, wherein the target point data and skin entry point data are obtained from one of: (a) the co-registered three dimensional image data set, and (b) two x-ray views taken under different view orientations using a triangulation technique;
generating a line on the display, where the line intersects the target point and the skin entry point and defines a planned instrument trajectory; and
adjusting the movable arm to a position at which an x-ray image taken using the x-ray source and x-ray detector results in the target point and the skin entry point being superimposed on each other;
whereby alignment of an instrument positioned between the x-ray source and the skin entry point is verified as an acceptable position with respect to the planned instrument trajectory when the instrument appears on the display as a point overlying the target point and the skin entry point in a verification x-ray image taken using the x-ray source and x-ray detector.

2. The method of claim 1, wherein the step of providing a three-dimensional image data set of a patient tissue region comprises obtaining a plurality of x-ray images acquired under different view directions and using the plurality of x-ray images to obtain a movable arm tomographic reconstruction.

3. The method of claim 1, wherein the step of obtaining an x-ray image of the patient tissue region using the x-ray source and the x-ray detector comprises obtaining a plurality of x-ray images and displaying the plurality of x-ray images on the display.

4. The method of claim 3, further comprising the step of displaying a three-dimensional rendering of the three-dimensional image data set on the display along with the two-dimensional x-ray images and an overlay image representing a 2-dimensional rendering of the 3-dimensional image data set.

5. The method of claim 4, wherein the skin entry point, the target point and the planned instrument trajectory are graphically displayed in their respective positions on the plurality of displayed x-ray images, the three-dimensional rendering and the overlay image.

6. The method of claim 1, wherein the step of adjusting the movable arm comprises determining a spatial orientation within the three-dimensional image data set at which the target point and skin entry point are superimposed on each other, and automatically moving the movable arm such that a further x-ray image obtained using the x-ray source and x-ray detector images the target point and skin entry point onto the same pixels of the x-ray detector.

7. The method of claim 1, wherein the acceptable position with respect to the planned instrument trajectory is verified by taking multiple x-ray images using the x-ray source and x-ray detector at movable arm positions oblique to the position of the movable arm used to obtain the verification x-ray image.

8. The method of claim 1, wherein the step of obtaining skin entry point data further comprises using one of a biopsy grid and a radio-opaque biopsy mesh.

9. The method of claim 1, wherein the steps of obtaining target point data and obtaining skin entry point data within two x-ray views taken under different view orientations using a triangulation technique comprises obtaining target point data and skin entry point data from each of the two x-ray views and calculating a three-dimensional location of each of the target point and skin entry point in the three-dimensional image data set using information obtained during the co-registering step.

10. The method of claim 1, wherein the co-registering step comprises applying a transform to the 3-dimensional image data set such that points in a resulting overlay image align with counterpart points in the x-ray image.

11. The method of claim 1, wherein the co-registering step comprises minimizing an error metric based on the gray levels of a resulting overlay image and the x-ray image.

12. A system for planning a percutaneous procedure for use in a system comprising an imaging system having a movable arm, an x-ray source and an x-ray detector and a display and a system controller connected to and in communication with the imaging system and display, and a machine-readable storage medium encoded with a computer program code such that, when the computer program code is executed by a processor, the processor performs a method comprising:
obtaining a three-dimensional image data set of a patient tissue region;
obtaining an x-ray image of the patient tissue region using the x-ray source and the x-ray detector;
co-registering the three-dimensional image data set to an x-ray image acquired using the imaging system;
obtaining target point data representative of a target point within the patient tissue region, and obtaining skin entry point data representative of a skin entry point, wherein the target point data and skin entry point data are obtained from one of: (a) the co-registered three dimensional image data set, and (b) two x-ray views taken under different view orientations using a triangulation technique;
generating a line on the display of the combined image, where the line intersects the target point and the skin entry point and defines a planned instrument trajectory; and
adjusting the movable arm to a position at which an x-ray image taken using the x-ray source and x-ray detector results in the target point and the skin entry point being superimposed on each other;
whereby alignment of an instrument positioned between the x-ray source and the skin entry point is verified as an acceptable position with respect to the planned instrument trajectory when the instrument appears on the display as a point overlying the target point and the skin entry point in a verification x-ray image taken using the x-ray source and x-ray detector.

13. The system of claim 12, wherein the step of providing a three-dimensional image data set of a patient tissue region comprises obtaining a plurality of x-ray images acquired under different view directions and using the plurality of x-ray images to obtain a movable arm tomographic reconstruction.

14. The system of claim 12, wherein the step of obtaining target point and a skin entry point data within two x-ray views taken under different view orientations using a triangulation technique comprises obtaining target point data and skin entry point data from each of the two x-ray views and calculating a three-dimensional location of each of the target point and skin entry point in the three-dimensional image data set using information obtained during the co-registering step.

15. The system of claim 12, wherein the step of obtaining an x-ray image of the patient tissue region using the x-ray source and the x-ray detector comprises obtaining a plurality of x-ray images and displaying the plurality of x-ray images simultaneously on the display.

16. The system of claim 15, wherein the method performed by the processor further comprises the displaying a three-dimensional rendering of the three-dimensional image data set on the display along with the x-ray image and MPR views generated from the three dimensional image data set.

17. The system of claim 16, wherein the skin entry point, the target point and the planned instrument trajectory are graphically displayed in their respective positions on the plurality of displayed x-ray images, the three-dimensional rendering and the MPR views.

18. The system of claim 12, wherein the step of adjusting the movable arm comprises determining a spatial orientation within the three-dimensional image data set at which the target point and skin entry point are superimposed on each other, and automatically moving the movable arm such that a further x-ray image obtained using the x-ray source and x-ray detector images the target point and skin entry point onto the same pixels of the x-ray detector.

19. The system of claim 12, wherein the acceptable position with respect to the planned instrument trajectory is verified from multiple x-ray images using the x-ray source and x-ray detector at movable arm positions parallel or oblique to the position of the movable arm used to obtain the verification x-ray image

20. The system of claim 12, wherein the step of obtaining skin entry point data further comprises using one of a biopsy grid and a radio-opaque biopsy mesh.

21. The system of claim 12, wherein the co-registering step comprises applying a transform to the 3-dimensional image data set such that points in a resulting overlay image align with counterpart points in the x-ray image.

22. The system of claim 12, wherein the co-registering step comprises minimizing an error metric based on the gray levels of a resulting overlay image and the x-ray image.

23. A method for planning a percutaneous procedure for use in a system comprising an imaging system having a movable arm, an x-ray source and an x-ray detector and a display and a system controller connected to and in communication with the imaging system and display, comprising:
obtaining a three-dimensional image data set of a patient tissue region;
obtaining an x-ray image of the patient tissue region using the x-ray source and the x-ray detector and displaying the x-ray image on a first portion of the display;
obtaining a multi-planar reformatting (MPR) view generated from the three-dimensional image data set and displaying the MPR view on a second portion of the display;
co-registering the three-dimensional image data set to the x-ray image and displaying the combined image on a third portion of the display;
displaying a three-dimensional rendering of the three-dimensional data set on a fourth portion of the display;
obtaining target point data from the combined image, the target point data representative of a target point within the patient tissue region;
obtaining skin entry point data from the combined image;
displaying the target point, the skin entry point, and a line connecting the two points on each of the x-ray image, the MPR view, the combined image, and the three-dimensional rendering on the display, where the line connecting the two points represents a planned instrument trajectory; and
adjusting the movable arm to a position at which an x-ray image taken using the x-ray source and x-ray detector results in the target point and the skin entry point being superimposed on each other on at least one of the x-ray image, the MPR view, the combined image and the three-dimensional rendering on the display;
whereby alignment of an instrument positioned between the x-ray source and the skin entry point is verified as an acceptable position with respect to the planned instrument trajectory when the instrument appears on the display as a point overlying the target point and the skin entry point in a verification x-ray image taken using the x-ray source and x-ray detector.

24. The method of claim 23, wherein the step of providing a three-dimensional image data set of a patient tissue region comprises obtaining a plurality of x-ray images acquired under different view directions and using the plurality of x-ray images to obtain a movable arm tomographic reconstruction.

25. The method of claim 23, wherein the step of obtaining target point data and skin entry point data from the combined image comprises obtaining target point data and skin entry point data from each of two x-ray views and calculating a three-dimensional location of each of the target point and skin entry point in the three-dimensional image data set using information obtained during the co-registering step.

26. The method of claim 23, wherein the step of obtaining a three-dimensional image data set comprises a technique selected from the group consisting of magnetic resonance imaging (MRI), Positron emission tomography (PET), computer tomography (CT x-ray), and Movable arm CT.

27. The method of claim 26, wherein the step of adjusting the movable arm comprises determining a spatial orientation within the three-dimensional image data set at which the target point and skin entry point are superimposed on each other, and automatically moving the movable arm such that a further x-ray image obtained using the x-ray source and x-ray detector images the target point and skin entry point onto the same pixels of the x-ray detector.

28. The method of claim 27, wherein the step of adjusting the movable arm is performed manually by a user.

29. The method of claim 23, wherein the step of verifying the position of the instrument comprises an auto-collimation technique in which collimators are positioned so that the skin entry point and the target point are visible.

30. The method of claim 23, wherein the acceptable position with respect to the planned instrument trajectory is verified by taking multiple x-ray images using the x-ray source and x-ray detector at movable arm positions oblique to the position of the movable arm used to obtain the verification x-ray image.

31. The method of claim 23, wherein the co-registering step comprises applying a transform to the 3-dimensional image data set such that points in a resulting overlay image align with counterpart points in the x-ray image.

32. The method of claim 23, wherein the co-registering step comprises minimizing an error metric based on the gray levels of a resulting overlay image and the x-ray image.
